(19) United States
(12) Patent Application Publication
(10) Pub. No.: US 2007/0177107 A1
(43) Pub. Date: Aug. 2, 2007

(54) Illumination arrangement for color picture projection

(76) Inventor: Eberhard Piehler, Lehesten (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/643,043

(22) Filed: Dec. 20, 2006

(30) Foreign Application Priority Data
Dec. 21, 2005 (DE) 10 2005 061 182.6

(51) Int. Cl. G03B 21/26

(52) U.S. Cl. 353/33; 353/94

(57) ABSTRACT

This invention involves a lighting arrangement for color image projection with at least two lighting units, whose light will hit image-forming elements, such as DMDs or grating light valves via optical elements, so that a subsequent optical projection system will project a multi-colored image on a projection surface. This invention shows that the illuminating optical paths will hit one or more image-forming elements from different directions and that once they pass the image-forming element or elements, they will be combined into one common optical projection path.

### RELATED APPLICATION

The present application claims the benefit of priority to German Patent Application No. 10 2005 061 182.6 filed on Dec. 21, 2005. Said application is incorporated by reference herein.

### FIELD OF THE INVENTION

The invention relates to lighting arrangement to project color images with at least two lighting units via optical elements. The light passes through image-forming modulators, such as DMDs or grating light valves via optical elements, so that a subsequent optical projection system will project a multi-colored image on a projection surface.

### BACKGROUND OF THE INVENTION

There are a number of known lighting arrangements for color image projection, which use only one image-forming element (single-chip arrangement) or multiple image forming elements (multi-chip arrangements).

DE 10127617 A1, for example, describes a projection arrangement with one lighting unit to create an illuminated field. Here, an image-forming element (light modulator) modulates the light coming from the lighting unit at the image-forming element. Then, an image is projected into the intermediate image layer via an optical projection system. The optical projection system has imaging optics with a mirror and a lens between the image-forming element and the mirror. Here, the light coming from the image-forming element and reflected by the mirror (optical projection path) transits the lens a second time.

Usually, lighting concepts assume broadband light sources. With multi-chip systems, the light emitted by a light source is distributed to the different chips by corresponding systems. With single-chip systems, a color wheel modulates the light.

Furthermore, there are known micro display systems that do not use light sources with a broad spectrum but narrow band sources, such as LEDs or laser light sources. Analogous to the use of broadband light sources, in order to illuminate a display, the different sources in a spectrum are overlapped by color separators; thus, similar lighting concepts are used, just like with conventional lighting.

Arrangements of this type have the disadvantage of being relatively large, and it is often very difficult to house these in the limited space of a device. Furthermore, the combination of different spectrums also represents high requirements for the color separators used, especially when three or more light sources must be overlapped.

### SUMMARY OF THE INVENTION

Based on these disadvantages, this invention intends to further develop a lighting arrangement for color image projection by using monochromatic light sources with the goal of allowing for an effective overlapping of light sources while at the same time reducing the size of the system using relatively simple resources.

This task is fulfilled by a lighting arrangement such as the one described at the beginning of this document. An arrangement of this type means that the light beams reach one or more image-forming elements separately from at least two directions and will subsequently be combined into one projection beam after they have passed the image-forming element.

Using reflective image-forming elements, where the beam deflections of the illuminating light do not concur with the reflections on the layer of the image-forming element, creates an advantage.

The optical paths for illumination have different spectrums, while the spectrums of the different illumination paths can be disjunctive or partially overlapped.

The invention shows advantageous arrangements for single-chip and multi-chip formations:

When using only one image-forming element, it is advantageous to use a prism arrangement with two air gaps (double-sided TIR prism). Here, the positioning of the air gap is determined by opposite angles to the common reference layer; one optical path is directed toward each air gap, which consists of one or more basic colors and the two optical paths are separately directed toward the image-forming element. The image-forming element combines the optical paths of the lighting system into the optical projection path.

For practical purposes, a system is planned that will allow a synchronization between the image-forming element and the optical paths of the lighting system. The image-forming element will then be able to modulate the alternatively illuminated optical paths. Especially when a DMD is used as an image-forming element, this can mean that the on and off statuses of the DMD are interchanged for the two optical paths.

In order to generate additional color portions, the invention creates a system of time-controlled color overlapping within one or both optical paths. This will allow the generation of three-color setup or of more colors.

The orientation of two separate optical paths toward the image-forming element allows the time overlapping of relatively close or even transcending spectrums by means of the image-forming element. Contrary to conventional lighting arrangements, no dichroite is used for the overlapping of the two optical paths of the lighting system to the optical projection system, which would enlarge its size.

Another advantage of this invention is to realize the illumination of the image-forming elements via an intermediate imaging system.

Here, the solution described in the “State-of-the-art” section is equipped with two light sources that can be time-modulated in order to illuminate the image-forming element via the optical paths that are oriented in different directions.

Another embodiment includes multiple intermediate imaging systems in order to create an overlap between partial images in the area of the intermediate image. This could be made possible by using dichroites or polarization beam splitters. If you generate two intermediate images with different polarization, you can create 3D effects with the respective auxiliary measures.

It is also advantageous to design a two-piece optical projection system including a projection lens and a field lens. Here, the field lens will be used to illuminate an image-forming element as well as to project the modulated image (field lens design). Here, at least two lighting units are arranged so that their optical paths can be illuminated via the field lens from different directions and combined in the modulated optical projection path. The field lens can also be designed as a complex optical system consisting of different optical elements.

When using three image-forming elements (multi-chip systems), the invention includes a prism arrangement consisting of at least four partial prisms. Three of these prisms are arranged so that the even surface of a partial prism is parallel to the image-forming element.

Another surface of the partial prism is used for the entrance of the light of a basic color, while the third surface of each partial prism incorporates a fourth partial prism. Here, the composite surfaces of the fourth partial prism, which are in contact with the composite surfaces of the first and second prism, are coated with color separating layers. The color portions reflected by the image-forming elements are thus overlapped into a common optical projection path.

With only four partial prisms, each image-forming element is illuminated via another path (optical path), while the optical projection path is overlapped by all three image-forming elements by the color separating layers. The prisms, via which the optical paths reach the different chips, are designed to generate total reflections wherever they touch the air gaps of the enclosed prism.

### BRIEF DESCRIPTION OF THE DRAWINGS

The following examples will describe the lighting arrangement in this invention in more detail. The figures depict the following:

FIG. 1: a first prism arrangement to illuminate an image-forming element;

FIG. 2: a second prism arrangement to illuminate an image-forming element;

FIG. 3: a prism arrangement to illuminate three image-forming element;

FIG. 4: an intermediate imaging system with two lighting units;

FIG. 5: an arrangement with one field lens to be used for illumination and projection.

### DETAILED DESCRIPTION

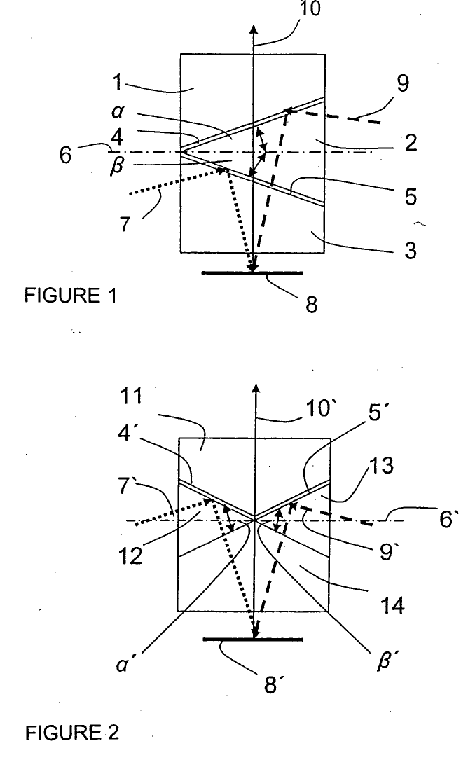

FIG. 1 shows a combination of three connected prisms 1, 2 and 3, where air gaps 4 and 5 are present between the composite surfaces of prisms 1 and 2 and between prisms 2 and 3. Prisms 1, 2 and 3 are designed so that their composite surfaces have exact opposite angles (β=β) to a reference plane. An optical path 7 from a monochromatic light source, such as the color green, penetrating into prism 3, hits air gap 5 and is reflected by this gap onto an image-forming element 8, such as a DMD. A second optical path 9 of a monochromatic light source, such as a red one, reaches the air gap 9 through prism 2 and is also reflected onto the image-forming element 8. Then, the unification of the two optical paths 7 and 9 takes place at the image-forming element 8 to form the common optical projection path 10. Via a switch arrangement (not pictured), the different monochromatic light sources can be switched on and off, so that the different color channels can be modulated separately. The triggering of the image-forming element 8 takes place so that the on and off status is interchanged between the optical paths 7 and 9. Also feasible is an overlapping of single color portions in the front area of the lighting system, so that a three-color setup or a setup with even more colors can be generated via the image-forming element 8.

Another alternative of the prism arrangement is shown in FIG. 2. This includes prisms 11, 12, 13 and 14.

Analogous to the arrangement in FIG. 1, air gaps 4′ and 5′ are present, where the optical paths 7′ and 9′ are reflected totally toward the image-forming element 8′. This is where the unification into a common optical projection path 10′ takes place. The positioning of the composite surfaces characterized by the air gaps 4′ and 5′ between prisms 12 and 14 as well as between prisms 13 and 14 is defined by the angles α′ and β′.

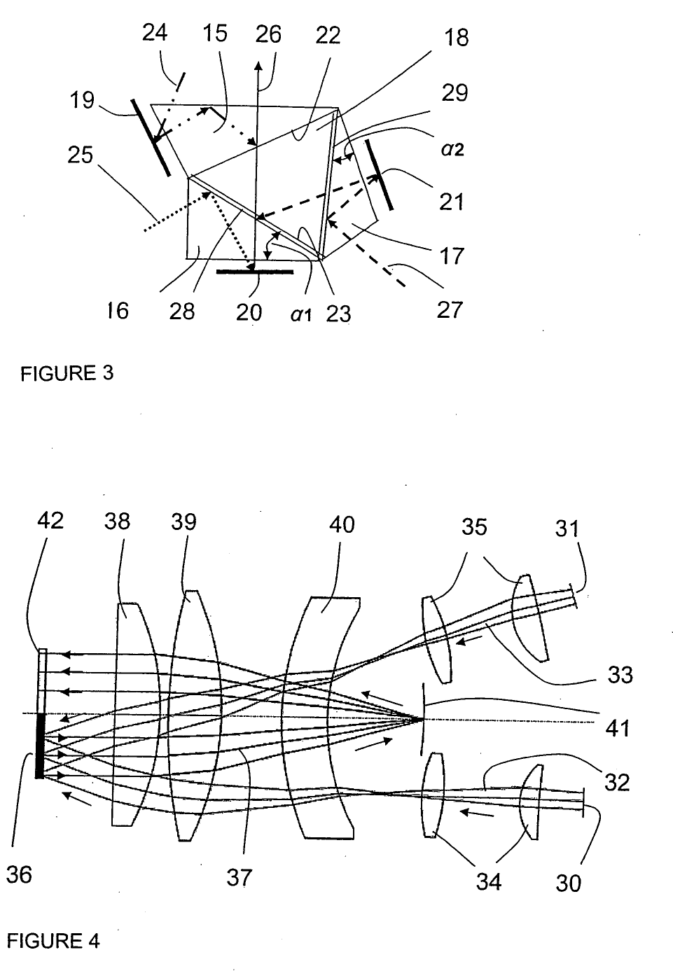

FIG. 3 shows a design alternative with four prisms 15, 16, 17 and 18 and three image-forming elements 19, 20 and 21.

One even surface each of the prisms 15, 16 and 17 is arranged parallel to the respective image-forming element 19, 20 and 21. Another surface of each prism 15, 16 and 17 is used for the light intrusion of a basic color, while the third surface of each of the three prisms 15, 16 and 17 abuts the fourth prism 18. The composite surfaces of the fourth prism 18, which are in contact with the composite surfaces of prisms 15 and 16, are coated with color separating layers 22 and 23. Optical path 24, which is marked by the basic color red, reaches the image-forming element 19 via the first outer surface of prism 15. The portion (projection light) reflected by the image-forming element 19 hits the color separating layer 22 via the second outer surface of prism 15, and overlaps with the color portion of the optical path marked by the color green, which is reflected by the image-forming element 20. This reflected color portion also makes up the common optical projection path 26, which is also hit by the color portion of the optical path 27 marked by the color blue, which is reflected by the image-forming element 21, via the color separating layer 23. To illuminate the image-forming elements 19 and 20, air gaps 28 and 29 are located between the composite surfaces of prisms 16 and 18 and the composite surfaces of prisms 17 and 18, so that the optical paths 25 and 27 can be totally reflected in the direction of the image-forming elements 20 and 21. Due to the condition of the total reflection for the optical paths 25 and 27, the selection of materials for prisms 16 and 17 and the necessary lighting angles at the image-forming elements 20 and 21, the angles α1 and α2 of the prisms 16 and 17 are defined.

The described prism combinations are only examples for a multitude of possible combinations, which unite several optical light paths into one optical projection path once they have passed the image-forming element or image-forming elements.

In addition to the shown alternatives with one or three image-forming elements, other alternatives can be realized, such as two image-forming element configurations.

FIG. 4 shows an intermediate imaging system with one lighting unit 30 and one lighting unit 31, which are marked by three field points each. The optical paths 32 and 33, which are emitted by the lighting units 30 and 31, hit an image-forming element 36 via illumination systems 34 and 35 (not described in detail); there, they are combined into one common image-modulated optical projection path 37. An intermediate image is created on image layer 42 via an optical imaging system located behind the image-forming element 36, which consists of lenses 38, 39 and 40 as well as a mirror 41. The deflecting mirror 41 (pupil of intermediate image) directs the modulated optical projection path 37 through the lenses 40, 39 and 38 into the intermediate image layer 42 a second time.

Compared to prism combinations with relatively long optical paths, an arrangement of this kind has the advantage that the actual projection lens can be designed without long optical paths and that no reflection conditions from the lighting within the projection lens must be taken into consideration. This allows the development of small and simple projection lenses. A setup of this kind bears advantages, especially for a device concept with a number of different projection lenses for different areas of use (focal length, zoom factor, lens shift).

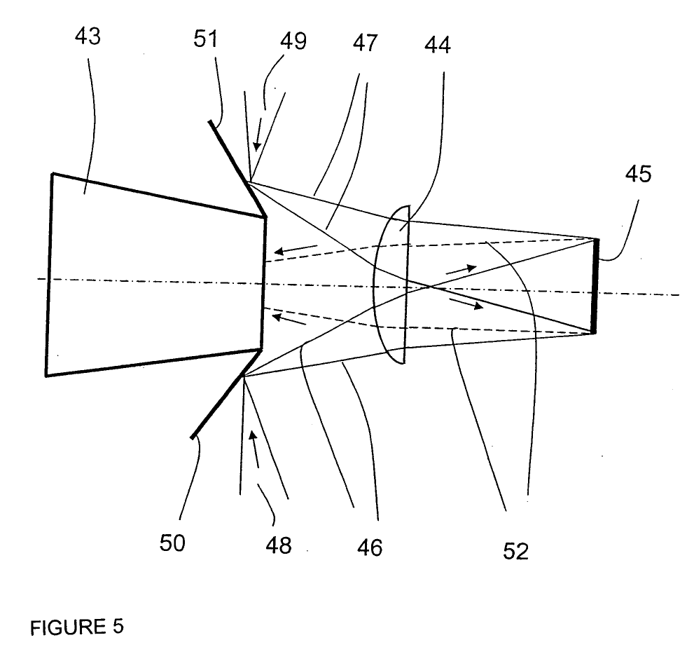

FIG. 5 shows an example with a two-part projection lens, consisting of a projection lens 43 and a field lens 44. Here, the field lens 44 is used for the lighting of an image-forming element 45 as well as for the projection of the image modulated by the image-forming element 45 (field lens design). Also, with this layout alternative, two optical paths 46 and 47 are planned to illuminate the image-forming element 45.

The image-forming element 45 is illuminated via the lighting units 48 and 49, which are depicted as cones of light. For this, the optical path 46 emitted by the lighting unit 48 is deflected at the deflection mirror 50 toward the field lens 44, defined there and then pointed to the image-forming element 45. Analogous to this beam line, the optical path 46, which originates in the lighting unit 49 and travels toward the field lens 44 via a deflection mirror 51, becomes optical path 47 and hits the image-forming element 45. Due to the double function of field lens 44, the image modulated by the image-forming element 45 is directed to the projection lens 43 in a common optical projection path 52. This alternative has the advantage that the different elements can be integrated into fairly small modules and that undesired reflections, which can occur with prism combinations, are avoided.

1-10. (canceled)

11. A lighting arrangement for color image projection, comprising:
at least two lighting units, whose light output is directed to image-forming elements via optical elements, so that a multi-colored image is projected on a projection surface via an adjacent optical projection system wherein two optical paths of the light output strike the one or more image-forming elements in separate beams from at least two different directions and are combined into a common optical projection path.

12. The lighting arrangement for color image projection as claimed in claim 11, wherein the reflective image-forming elements comprise DMDs or grating light valves.

13. The lighting arrangement for color image projection as claimed in claim 11, wherein the at least two lighting units each emit light having a different spectral range than the other.

14. The lighting arrangement for color image projection as claimed in claim 13, wherein the different spectral ranges partially overlap.

15. The lighting arrangement for color image projection as claimed in claim 11, further comprising a prism arrangement that guides the optical paths to illuminate the reflective image-forming elements.

16. The lighting arrangement for color image projection as claimed in claim 15, wherein, when only one image-forming element is used, the prism arrangement comprises:
at least three prisms separated by two air gaps;
the positioning of the two air gaps being defined by opposing angles relative to a common reference plane; and
further wherein an optical path of a basic color or an optical path comprising at least two basic colors is directed toward each of the two air gaps; and the two optical paths are directed toward the image-forming element separately from different positions.

17. The lighting arrangement for color image projection as claimed in claim 15, wherein when three image-forming elements are used and the prism arrangement comprises at least four prisms, wherein three of the prisms are arranged so that a first surface of each of the three prisms is substantially parallel to one of the three image-forming elements;
further wherein a second surface of each of the three prisms is penetrated by a beam of light of at least one basic color;
further wherein a third surface of each of the three prisms is oriented substantially parallel to a surface of the fourth prism,
further wherein two of the surfaces of the fourth prism are in contact with composite surfaces of two of the three prisms and are coated with color separating layers;
further wherein an air gap separates a third surface of the fourth prism from a third of the three prisms; and
wherein color portions reflected by the image-forming elements are combined into a common optical projection path.

18. The lighting arrangement for color image projection as claimed in claim 11, further comprising a lens system and beam deflection elements to guide the optical paths to illuminate the image-forming elements from different directions.

19. The lighting arrangement for color image projection as claimed in claim 18, wherein an intermediate image is formed in an intermediate image layer via one or two beam deflection elements in the optical projection path; and
wherein the at least two lighting units are arranged so that their illumination optical paths illuminate the at least one image-forming element from different directions; and
wherein the illumination optical paths are combined into one modulated optical projection path.

20. The lighting arrangement for color image projection as claimed in claim 18, further comprising a projection lens and a field lens;
the field lens directing illumination to the image-forming element and also projecting a modulated image from the image forming element; and
wherein the at least two lighting units are arranged so that their optical paths illuminate the image-forming element via deflection elements through the field lens from different directions and are combined in the modulated optical projection path.

21. The lighting arrangement for color image projection as claimed in claim 11, wherein, for separate modulation of color channels, at least one of the two lighting units can be switched on or off.

22. The lighting arrangement for color image projection as claimed in claim 11, further comprising an arrangement with time-controlled color overlapping to generate additional color portions in a front area of the lighting units.
